(19) United States
(12) Patent Application Publication
(10) Pub. No.: US 2018/0245404 A1
(43) Pub. Date: Aug. 30, 2018

(54) CUTTER BOUND TO MATRIX DRILL BITS VIA PARTIAL TRANSIENT LIQUID-PHASE BONDS

(71) Applicant: Halliburton Energy Services, Inc., Houston, TX (US)

(72) Inventor: Grant O. COOK, III, Spring, TX (US)

(73) Assignee: Halliburton Energy Services, Inc., Houston, TX (US)

(21) Appl. No.: 15/756,562

(22) PCT Filed: Oct. 2, 2015
(86) PCT No.: PCT/US2015/053625

§ 371 Date: Feb. 28, 2018

(51) Int. Cl. E21B 10/573; E21B 10/55; E21C 35/183; B23K 1/00; B22F 7/06

(52) U.S. Cl. CPC E21B 10/573; E21B 10/55; B22F 2005/001; B23K 1/0006; B22F 7/064; E21C 35/183

(57) ABSTRACT

Bonding polycrystalline diamond compact (PDC) cutters to metal matrix composite (MMC) drill bits may be achieved with a partial transient liquid-phase (PTLP) bonding method that uses lower temperatures than comparable brazing methods. For example, an interlayer bonding structure positioned between a PDC cutter and the MMC may be heated to and maintained at a bonding temperature for a period of time sufficient to isothermally solidify the outer layers with the refractory layer and to react the outer layers with the hard composite substrate and to the MMC.

### BACKGROUND

The present application relates to securing polycrystalline diamond compact cutters to matrix drill bit bodies.

Drill bits and components thereof are often subjected to extreme conditions while drilling, such as high temperatures, high pressures, and contact with abrasive surfaces. Polycrystalline diamond compact (PDC) cutters are often positioned around a drill bit body to directly contact and cut the formation as the bit is rotated while drilling. Polycrystalline diamond compacts have beneficial properties for this purpose, such as wear resistance, hardness, and high thermal conductivity that enhance the lifetime of the drill bit.

A PDC cutter is commonly formed in a single high-pressure, high-temperature (HPHT) press cycle. First, diamond particles are placed together with a hard composite substrate in a press. During the HPHT press cycle, the diamond particles are sintered, and a so-called catalyzing material facilitates both the bonding between the diamond particles to form a polycrystalline diamond table and to attach the polycrystalline diamond table to the hard composite substrate. In most of the cases, the hard composite substrate provides a source for the catalyzing material (e.g., cobalt, nickel, iron, Group VIII elements, and any alloy thereof) to facilitate bonding between the diamond particles. For example, when cobalt-cemented tungsten carbide is the hard composite substrate, a cobalt catalyzing material may melt and infiltrate the interstitial spaces of the diamond particles. In some instances, catalyzing material may also be mixed with the diamond particles before sintering.

Immediately after the polycrystalline diamond table is formed, some catalyzing material typically remains within the interstitial spaces between the fused diamond particles. The residual catalyzing material in the polycrystalline diamond compact can cause or facilitate degradation of the polycrystalline diamond table. To mitigate these effects, a PDC is often leached to remove at least some of the catalyzing material from the interstitial spaces of the polycrystalline diamond compact near the working surface.

In some manufacturing process, the polycrystalline diamond table may be removed from the hard composite substrate so that the entire diamond table may be treated to remove some or all of the catalyzing material. Then, the polycrystalline diamond table may be re-attached (e.g., via brazing) to another hard composite substrate to form a PDC having some or all of the catalyzing material removed. This thorough approach to leaching and then re-attaching the diamond table may result in a thermally stable polycrystalline (TSP) diamond compact.

The quality and lifetime of the polycrystalline diamond increase with greater removal of the catalyzing material. However, the production of TSP diamond compacts typically takes days and uses harsh chemicals like strong acids at elevated temperatures. Also, the removal of the catalyzing material from the polycrystalline diamond generally reduces the wettability of the diamond compact and the resulting bond strength of the assembled PDC cutter.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a cross-sectional side view of a matrix drill bit having a matrix bit body formed by a metal-matrix composite (MMC).

FIG. 2 is an isometric view of the matrix drill bit that includes a plurality of PDC cutters.

FIG. 3 is a cross-sectional side view of a configuration suitable for mounting a PDC cutter in a pocket formed in the MMC of a matrix drill bit.

FIG. 3A is an expanded view of a portion of FIG. 3 illustrating a three-layer interlayer bonding structure between the hard composite substrate of the PDC cutter and the MMC of the matrix drill bit.

FIG. 3B is an expanded view of a portion of FIG. 3 illustrating a two-layer interlayer bonding structure between the hard composite substrate of the PDC cutter and the MMC of the matrix drill bit.

FIG. 4A is a cross-sectional side view of the PDC cutter mounted in a pocket formed in the MMC of the matrix drill bit of FIG. 3A.

FIG. 4B is a cross-sectional side view of the PDC cutter mounted in a pocket formed in the MMC of the matrix drill bit of FIG. 3B.

FIG. 5 is a cross-sectional side view of the PDC cutter mounted in a pocket formed in the MMC of the matrix drill bit of FIGS. 3A and 3B.

FIG. 6 is a cross-sectional side view of an interlayer bonding structure with five layers.

FIG. 7 is a schematic showing one example of a drilling assembly suitable for use in conjunction with matrix drill bits having PDC cutters mounted thereto.

### DETAILED DESCRIPTION

Systems and methods are disclosed whereby a PDC cutter may be secured to a drill bit body using transient liquid-phase (TLP) bonding and variations thereof. Generally, TLP bonding may be considered a hybrid between brazing and diffusion bonding processes to the extent that it is distinct from either brazing or diffusion bonding individually. In one implementation of TLP bonding, an interlayer material may be positioned between refractory substrates, where the interlayer material has a lower melting temperature than both refractory substrates. The assembled interlayer material and refractory substrates (i.e., the assembly) may be heated to a temperature within a temperature range sufficient to melt the interlayer material but not the refractory substrates. The assembly may be maintained within that temperature range until the liquid phase of the interlayer material has solidified due to interdiffusion with the refractory substrates. This solidification phenomenon, caused by change in composition rather than temperature, is referred to herein as isothermal solidification. The resultant TLP bond has a melting point greater than the melting point of the interlayer material due to the diffusion that occurs during the process. The melting point increase can be on the order of hundreds of degrees centigrade with the appropriate selection of process parameters, such as interlayer thickness, composition, and bonding temperature. TLP bonding can be used to bond metallic materials due to its reliance on interdiffusion with the substrate materials.

The present disclosure is directed in part to methods of bonding a PDC cutter to a matrix drill bit body using a variation of transient liquid-phase bonding known as partial transient liquid-phase (PTLP) bonding. PTLP may generally be used to bond two ceramic parts, and more particularly, as taught herein, to bond the hard composite substrate of a PDC cutter to the MMC bit body. What is referred to herein as the interlayer bonding structure used in PTLP is multi-layered. In a three-layer structure, for example, the interlayer bonding structure may include a refractory layer sandwiched between two outer layers. The interlayer bonding structure may be positioned between the substrates or parts to be bonded. The bonding order of components in this example could be the hard composite substrate of the PDC cutter, the first outer layer of the interlayer bonding structure, the refractory layer of the interlayer bonding structure, the second outer layer of the interlayer bonding structure, and the MMC bit body. The outer layers of the interlayer bonding structure may be, for example, a metal or metal alloy having a lower melting point than each of the refractory layer and the substrates, in this example the hard composite substrate of the PDC cutter and the MMC bit body. Upon melting, the two outer layers serve two functions: (1) each interdiffuses on one side with the refractory layer to induce isothermal solidification, similar to the TLP bonding process and (2) each reacts on the other side with the adjacent substrate (e.g., the hard composite substrate and MMC, with a net effect of bonding the two components (e.g., the PDC cutter to the matrix bit body).

In one implementation, by using a PTLP bonding method, the bonding temperature may be kept below the graphitization temperature of diamond, specifically, below 1472° F., while producing a bond that has a melting point greater than 1472° F. In some embodiments, the resulting bond may have a melting point greater than 1500° F., 1600° F., or 1700° F. In yet other embodiments, the bonding temperature may be kept below 1400° F., 1300° F., or 1200° F.

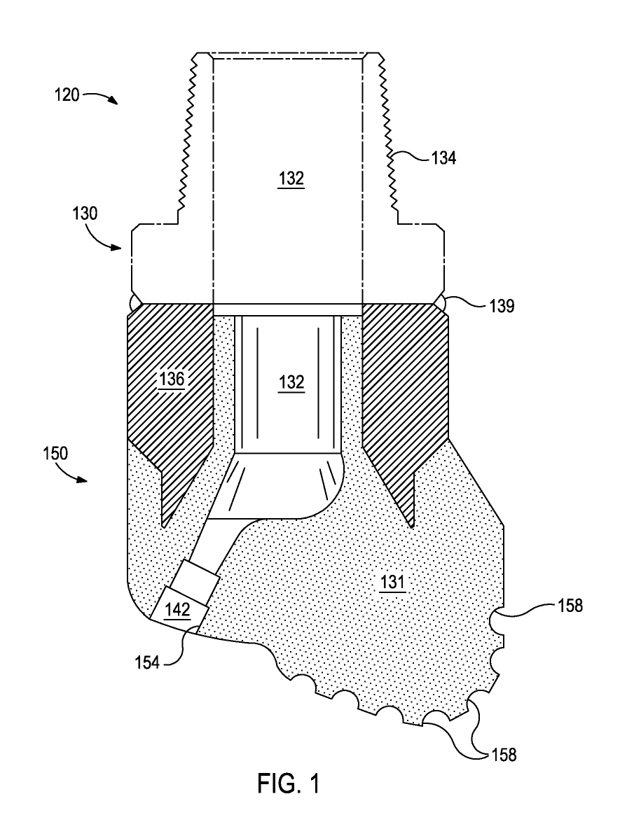

FIG. 1 is a cross-sectional side view of a matrix drill bit 120 having a matrix bit body 150 formed by a metal-matrix composite (MMC) 131 (e.g., reinforcing particles of tungsten carbide dispersed in a binder alloy). As used herein, the term “matrix drill bit” encompasses rotary drag bits, drag bits, fixed-cutter drill bits, and any other drill bit having a matrix bit body and capable of incorporating the teachings of the present disclosure.

For embodiments such as those shown in FIG. 1, the matrix drill bit 120 may include a metal shank 130 with a metal mandrel or metal blank 136 securely attached thereto (e.g., at weld 139). The metal blank 136 extends into matrix bit body 150. The metal shank 130 includes a threaded connection 134 distal to the metal blank 136.

The metal shank 130 and metal blank 136 are generally cylindrical structures that at least partially define corresponding fluid cavities 132 that fluidly communicate with each other. The fluid cavity 132 of the metal blank 136 may further extend longitudinally into the matrix bit body 150. At least one flow passageway (shown as flow passageway 142) may extend from the fluid cavity 132 to exterior portions of the matrix bit body 150. Nozzle openings 154 may be defined at the ends of the flow passageways 142 at the exterior portions of the matrix bit body 150.

A plurality of indentations or pockets 158 are formed in the matrix bit body 150 and are shaped or otherwise configured to receive PDC cutters.

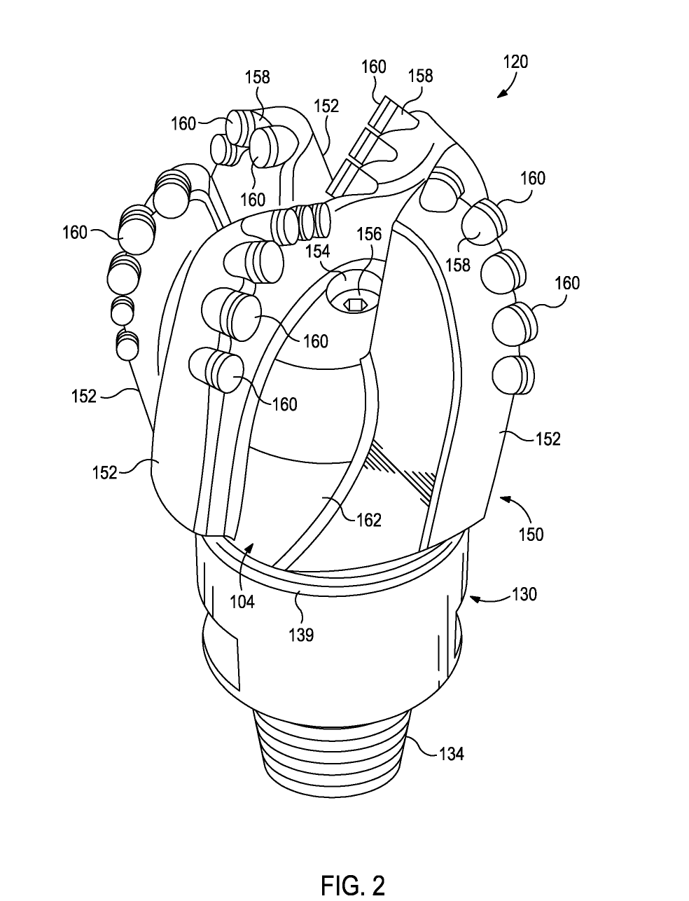

FIG. 2 is an isometric view of the matrix drill bit 120 of FIG. 1 that includes a plurality of PDC cutters 160 that may be fabricated according to embodiments of the present disclosure. As illustrated, the matrix drill bit 120 includes a plurality of cutter blades 152 arranged along the circumference of a bit head 104. The bit head 104 is connected to the metal shank 130 to form a matrix bit body 150. The cutter blades 152 may be spaced from each other on the exterior of the matrix bit body 150 to form fluid-flow paths or junk slots 162 therebetween.

As illustrated, the plurality of pockets 158 may be formed in the cutter blades 152 at selected locations. A PDC cutter 160 may be securely mounted (e.g., with the compositions and methods described further herein) in each pocket 158 to engage and remove portions of a subterranean formation during drilling operations. More particularly, each PDC cutter 160 may scrape and gouge formation materials from the bottom and sides of a wellbore during rotation of the matrix drill bit 120 by an attached drill string. A nozzle 156 may be positioned in each nozzle opening 154.

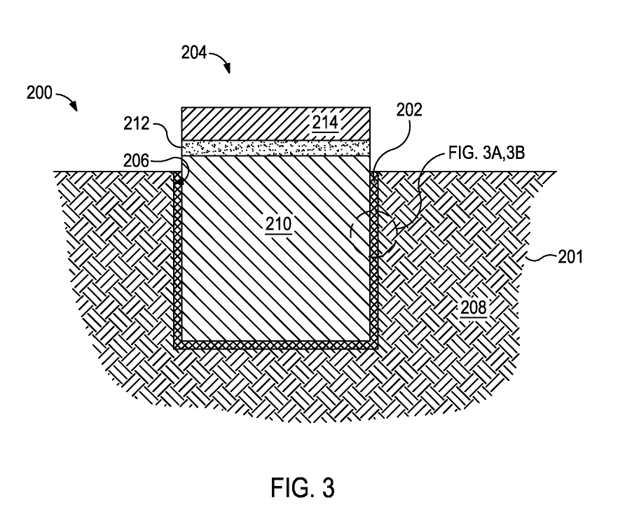

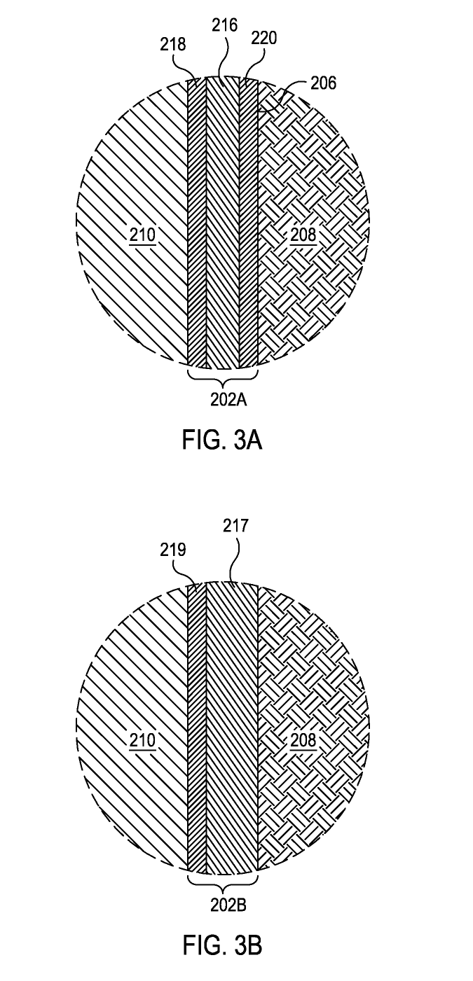

FIG. 3 is a cross-sectional side view of an exemplary configuration 200 for an interlayer bonding structure 202 positioned between a PDC cutter 204 and a pocket 206 formed in the MMC 208 of a matrix drill bit, according to at least some embodiments of the present disclosure. The PDC cutter 204 includes a hard composite substrate 210 (e.g., cemented carbide) bonded at bonding joint 212 to a polycrystalline diamond compact 214. The pocket 206 formed in the MMC 208 is configured for receiving the PDC cutter 204.

The interlayer bonding structure 202 may be positioned between the hard composite substrate 210 of the PDC cutter 204 and the MMC 208 of the matrix drill bit 201 by a plurality of methods. For example, the interlayer bonding structure 202 may be a multi-layer foil placed on the surface of the pocket 206 or on the surface of the hard composite substrate 210 before placing the PDC cutter 204 in the pocket 206. Alternatively, the individual layers of the interlayer bonding structure 202 may be a foil, a paste, or a powder that are assembled in the proper order on the surface of the pocket 206, on the surface of the hard composite substrate 210, or both to form the interlayer bonding structure 202 once the PDC cutter 204 is placed in the pocket 206. Additionally, in some instances, one or more of the individual layers of the interlayer bonding structure 202 may be deposited on the surface of the pocket 206 or on the surface of the hard composite substrate 210 by sputtering, thermal spray, physical vapor deposition, chemical vapor deposition, electrolytic deposition, electroless deposition, or the like.

As illustrated, the interlayer bonding structure 202 lines the entire pocket 206. However, in alternate embodiments, the interlayer bonding structure 202 may be positioned between only a portion of the hard composite substrate 210 and MMC 208. For example, the interlayer bonding structure 202 may be positioned between only the sides of the pocket 206 and not the bottom portion of the pocket 206. Alternatively, the interlayer bonding structure 202 may be positioned in only the bottom of the pocket 206. Other configurations of the interlayer bonding structure 202, hard composite substrate 210, and MMC 208 may also be implemented.

The interlayer bonding structure 202 of FIG. 3 may have any of a variety of multi-layer configurations. For example, FIG. 3A illustrates an optional three-layer interlayer bonding structure 202A, and FIG. 3B illustrates an alternative two-layer interlayer bonding structure 202B.

FIG. 3A is an enlarged view of the dashed area of FIG. 3 illustrating an optional three-layer interlayer bonding structure 202A according to one embodiment of a PDC cutter pocket mounting. The three-layer interlayer bonding structure 202A is provided between the hard composite substrate 210 of the PDC cutter 204 and the MMC 208 of the matrix drill bit 201 of FIG. 3. The three-layer interlayer bonding structure 202A in this example configuration includes a refractory layer 216 sandwiched between two metal or metal alloy outer layers 218, 220.

FIG. 3B is an enlarged view of the indicated area of FIG. 3 illustrating a two-layer interlayer bonding structure 202B according to one embodiment of a PDC cutter pocket mounting. The two-layer interlayer bonding structure 202B includes a refractory layer 217 and an outer layer 219 where the refractory layer 217 abuts the MMC 208 of the matrix drill bit 201 of FIG. 3 and the outer layer 219 abuts the hard composite substrate 210 of the PDC cutter 204 of FIG. 3.

After the interlayer bonding structure 202 is properly positioned in the configuration 200, a selected PTLP bonding method may be used to secure the PDC cutter 210 in the pocket 206. More specifically, the materials may be heated to bonding temperature that is (1) above the melting point of the outer layers 218,219,220 or above the lowest eutectic melting point of the outer layers 218,219,220, (2) below the melting point of the refractory layer 216,217, and, preferably, and (3) below the diamond graphitization temperature. The bonding temperature may range from 1000° F. to 1500° F. The interlayer bonding structures 202 are held at the bonding temperature for a time sufficient for the outer layers 218,219,220 to each interdiffuse on one side with the refractory layer 216,217 to induce isothermal solidification and each reacts on the other side with the adjacent substrate.

To achieve the desired bonding described herein, heating may be performed at a slow rate, especially as the temperature approaches the melting temperature of the outer layers 218,219,220. This may allow for the outer layers 218,219,220 to melt evenly and form more homogeneous bonds. In some instances, within 200° F. or less of the bonding temperature, heating may be at a rate of 3° F./min to 60° F./min. Once at the bonding temperature, the temperature may be held at the bonding temperature for 1 minute to 6 hours or more to achieve isothermal solidification of the interlayer bonding structure 202. Holding at the bonding temperature may also facilitate the formation of more homogeneous bonds.

Heating may be performed with radiation heating, conduction heating, convection heating, radio-frequency induction heating, resistance heating, infrared heating, laser heating, electron-beam heating, or a combination thereof.

In some instances, physical pressure (e.g., 1 kPa to 10 MPa) may also be applied to the configuration 200 (e.g., to the polycrystalline diamond compact 214 and/or the hard composite substrate 210) during heating to maintain the configuration 200 in the proper position and facilitate intimate contact during bonding. While bonding may preferably be performed at atmospheric pressure, in some instances, the bonding may be performed at reduced air pressures (e.g., 0.001 mTorr to 50 mTorr). Moreover, while bonding may preferably be performed in an air atmosphere, in some embodiments, the bonding may be performed, whether at reduced pressure or atmospheric pressure, in an inert atmosphere that contains gases like argon, nitrogen, helium, and the like, or mixtures thereof.

After heating to and holding at the bonding temperature, the materials may be cooled. In at least one embodiment, cooling may be undertaken at a rate of 3° F./min to 60° F./min for at least the first 200° F. and then, optionally, at a faster rate, as desired.

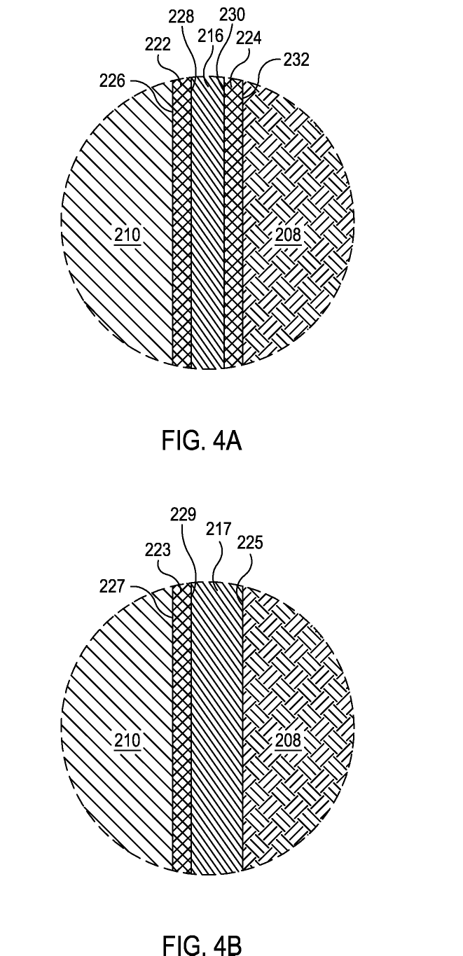

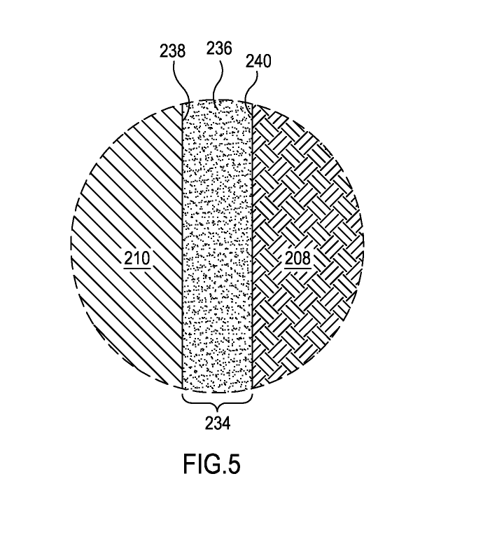

FIGS. 4A and 4B illustrate the bonds formed after a PTLP bonding method is performed on the three-layer interlayer bonding structure 202A and the three-layer interlayer bonding structure 202B, respectively.

FIG. 4A, with continued reference to FIGS. 3 and 3A, is a cross-sectional side view after bonding the PDC cutter 204 in a pocket 206 formed in the MMC 208 of a matrix drill bit of FIGS. 3 and 3A according to at least some embodiments of the present disclosure. A first bond 222 may be formed between the hard composite substrate 210 and the refractory layer 216, and a second bond 224 may be formed between the MMC 208 of the matrix drill bit and the refractory layer 216. The bonds 222,224 each have a melting point greater than the melting point of the two outer layers 218,220.

Because the outer layers 218,220 of FIG. 3A react differently with the abutting substrates, the bonds 222,224 formed comprise different portions. As used herein, the term “bonding portion” refers to a portion of a bond. The first bond 222 includes a metal-ceramic bonding portion 226 as a result of the outer layer 218 reacting with the hard composite substrate 210 and a TLP bonding portion 228 with the refractory layer 216 as a result of the outer layer 218 diffusing into the refractory layer 216. A second bond 224 includes a metal-composite bonding portion 232 with the MMC 208 as a result of the outer layer 220 reacting with the MMC 208 and a TLP bonding portion 230 with the refractory layer 216 as a result of the outer layer 220 diffusing into the refractory layer 216.

FIG. 4B, with continued reference to FIGS. 3 and 3B, is a cross-sectional side view after bonding the PDC cutter 204 in a pocket 206 formed in the MMC 208 of a matrix drill bit of FIGS. 3 and 3B according to at least some embodiments of the present disclosure. During the bonding process, the outer layer 219 may react with hard composite substrate 210 to form a first bond 223 with a metal-ceramic bonding portion 227 while also diffusing into refractory layer 217 to cause isothermal solidification and form TLP bonding portion 229. Further, the refractory layer 217 may form a second bond 225 with MMC 208 due to at least one of a chemical reaction, intermetallic phase formation, eutectic liquid formation that subsequently isothermally solidifies, or solid-state diffusion.

Bonds 222,223,224,225 of FIGS. 4A and 4B and the bonding portions 226,227,228,229,230,232 thereof are illustrated as being distinctly defined structures, which may occur in some instances. In other instances, the bonds 222,223,224,225 and the bonding portions 228,229,230,232 thereof may not be distinctly defined. For example, each of the bonding portions 228,229,230,232 and bond 225 may independently have a thickness associated therewith as a result of the interdiffusion and/or reaction having occurred with an abutting substrates. Further, in some instances, the bonds 222,223,224 may be composed essentially of their respective bonding portions 226,227,228,229,230,232. Due to the significant amount of diffusion that may occur during PTLP bonding, the TLP bonding portions 228,229,230,232, and the bond 225 may not be distinguishable by microscopy or composition analysis.

FIG. 5, with continued reference to FIGS. 3A and 3B, is a cross-sectional side view after bonding of the PDC cutter 204 in a pocket 206 formed in the MMC 208 of a matrix drill bit of FIG. 3 according to at least some embodiments of the present disclosure. In FIG. 5, the refractory layer 216,217 and outer layers 218,219,220 of FIGS. 3A and 3B are sufficiently sized (e.g., sufficiently thin) such that a bond 234 is formed between the hard composite substrate 210 of the PDC cutter 204 and the MMC 208 of the matrix drill bit that no longer contains the refractory layer 216,217 as a distinct layer. That is, during heating, the outer layers 218,219,220 diffuse sufficiently into the refractory layer 216,217 such that a TLP bond 236 is formed throughout what initially comprised the entire refractory layer 216,217. Therefore, the bond 234 is composed of (1) a metal-ceramic bonding portion 238 with the hard composite substrate 210 of the PDC cutter 204 that transitions to (2) the TLP bond 236 that transitions to (3) a metal-composite bonding portion 240 with the MMC 208 of the matrix drill bit. The bond 234 has a melting point greater than the melting point of the outer layers 218,219,220.

The illustrated examples of FIGS. 3, 3A, 3B, 4A, 4B, and 5 include or are based on a two- or three-layer interlayer bonding structure 202. In some embodiments, however, the interlayer bonding structure may have more than two or three layers. For example, interlayer bonding structures may be generally described as either (1) a layered structure comprising a first outer layer, a second outer layer, and at least one refractory layer between the first and second outer layers or (2) a layered structure comprising an outer layer and a refractory layer at an opposing surface of the interlayer bonding structure to the outer layer. Such descriptions do not preclude additional layers between (1) the first and second outer layers or (2) the outer layer and the refractory layer.

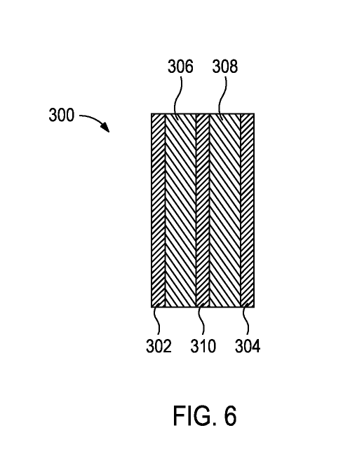

FIG. 6, for example, is a cross-sectional side view of an exemplary interlayer bonding structure 300 with five layers. The interlayer bonding structure 300 includes two outer layers 302,304, two refractory layers 306,308 positioned therebetween, and an intermediate layer 310. The intermediate layer 310 is sandwiched between the two refractory layers 306,308, and those three layers are sandwiched between the two outer layers 302,304. The intermediate layer 310 may be composed materials that directly melt or that form eutectic melts with the refractory layers 306,308, examples of which are described further herein.

Upon heating to the bonding temperature, the intermediate layer 310 may form a TLP bond, braze bond, or diffusion bond between the two refractory layers. The interlayer bonding structure 300 with five layers or other interlayer bonding structure configurations including those with a refractory layer configured to abut the MMC of the drill bit may be used as the interlayer bonding structure 202 of FIG. 3.

The matrix drill bits described herein with PDC cutters mounted thereto may be used in a drilling assembly.

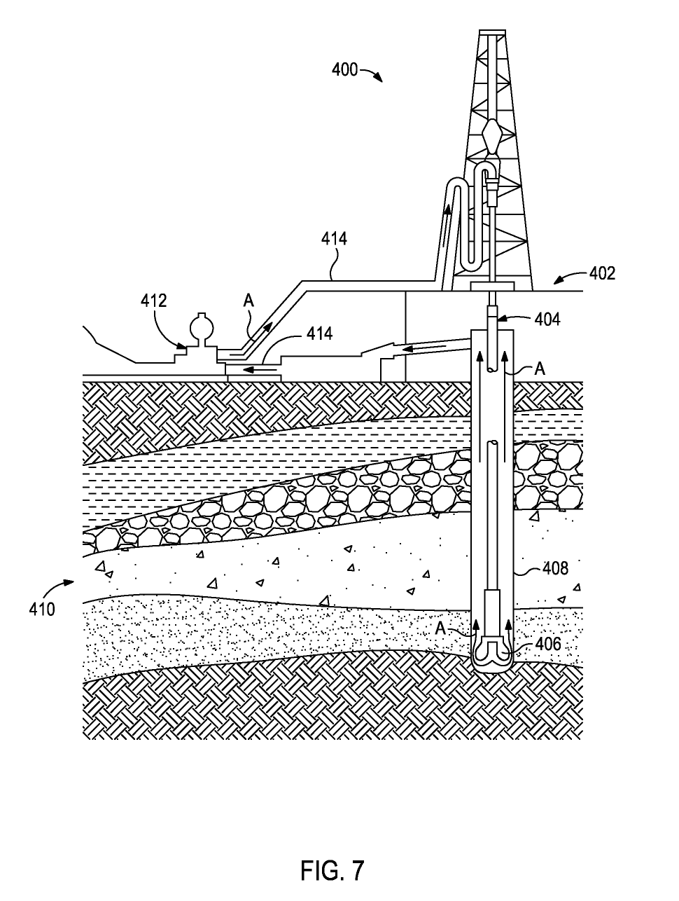

FIG. 7, for example, is a schematic diagram showing one example of a drilling assembly 400 suitable for use in conjunction with matrix drill bits having PDC cutters mounted thereto according to the present disclosure (e.g., mountings illustrated in FIGS. 4-5). It should be noted that while FIG. 7 generally depicts a land-based drilling assembly, those skilled in the art will readily recognize that the principles described herein are equally applicable to subsea drilling operations that employ floating or sea-based platforms and rigs, without departing from the scope of the disclosure.

The drilling assembly 400 includes a drilling platform 402 coupled to a drill string 404. The drill string 404 may include, but is not limited to, drill pipe and coiled tubing, as generally known to those skilled in the art apart from the particular teachings of this disclosure. A matrix drill bit 406 according to the embodiments described herein is attached to the distal end of the drill string 404 and is driven either by a downhole motor and/or via rotation of the drill string 404 from the well surface. As the drill bit 406 rotates, it creates a wellbore 408 that penetrates the subterranean formation 410. The drilling assembly 400 also includes a pump 412 that circulates a drilling fluid through the drill string (as illustrated as flow arrows A) and other pipes 414.

One skilled in the art would recognize the other equipment suitable for use in conjunction with drilling assembly 400, which may include, but is not limited to, retention pits, mixers, shakers (e.g., shale shaker), centrifuges, hydrocyclones, separators (including magnetic and electrical separators), desilters, desanders, filters (e.g., diatomaceous earth filters), heat exchangers, and any fluid reclamation equipment. Further, the drilling assembly may include one or more sensors, gauges, pumps, compressors, and the like.

There are a wide variety of materials that may be used in conjunction with the above-described matrix drill bit manufacturing and assembly and bonding of components. The MMC may comprise reinforcing particles dispersed in a binder material. Exemplary reinforcing particles of the MMC may include, but are not limited to, tungsten, molybdenum, niobium, tantalum, rhenium, iridium, ruthenium, beryllium, titanium, chromium, rhodium, iron, cobalt, uranium, nickel, nitrides, silicon nitrides, boron nitrides, cubic boron nitrides, natural diamonds, synthetic diamonds, cemented carbide, spherical carbides, low-alloy sintered materials, cast carbides, silicon carbides, boron carbides, cubic boron carbides, molybdenum carbides, titanium carbides, tantalum carbides, niobium carbides, chromium carbides, vanadium carbides, iron carbides, tungsten carbide (e.g., macrocrystalline tungsten carbide, cast tungsten carbide, crushed sintered tungsten carbide, carburized tungsten carbide, etc.), steels, stainless steels, austenitic steels, ferritic steels, martensitic steels, precipitation-hardening steels, duplex stainless steels, ceramics, iron alloys, nickel alloys, cobalt alloys, chromium alloys, HASTELLOY® alloys (i.e., nickel-chromium containing alloys, available from Haynes International), INCONEL® alloys (i.e., austenitic nickel-chromium containing superalloys available from Special Metals Corporation), WASPALOYS® (i.e., austenitic nickel-based superalloys), RENE® alloys (i.e., nickel-chromium containing alloys available from Altemp Alloys, Inc.), HAYNES® alloys (i.e., nickel-chromium containing superalloys available from Haynes International), INCOLOY® alloys (i.e., iron-nickel containing superalloys available from Mega Mex), MP98T (i.e., a nickel-copper-chromium superalloy available from SPS Technologies), TMS alloys, CMSX® alloys (i.e., nickel-based superalloys available from C-M Group), cobalt alloy 6B (i.e., cobalt-based superalloy available from HPA), N-155 alloys, and any mixture thereof.

Suitable binder materials of the MMC include, but are not limited to, copper, nickel, cobalt, iron, aluminum, molybdenum, chromium, manganese, tin, zinc, lead, silicon, tungsten, boron, phosphorous, gold, silver, palladium, indium, any mixture thereof, any alloy thereof, and any combination thereof. Exemplary binder material may include, but are not limited to, copper-phosphorus, copper-phosphorous-silver, copper-manganese-phosphorous, copper-nickel, copper-manganese-nickel, copper-manganese-zinc, copper-manganese-nickel-zinc, copper-nickel-indium, copper-tin-manganese-nickel, copper-tin-manganese-nickel-iron, gold-nickel, gold-palladium-nickel, gold-copper-nickel, silver-copper-zinc-nickel, silver-manganese, silver-copper-zinc-cadmium, silver-copper-tin, cobalt-silicon-chromium-nickel-tungsten, cobalt-silicon-chromium-nickel-tungsten-boron, manganese-nickel-cobalt-boron, nickel-silicon-chromium, nickel-chromium-silicon-manganese, nickel-chromium-silicon, nickel-silicon-boron, nickel-silicon-chromium-boron-iron, nickel-phosphorus, nickel-manganese, copper-aluminum, copper-aluminum-nickel, copper-aluminum-nickel-iron, copper-aluminum-nickel-zinc-tin-iron, and the like, and any combination thereof.

The hard composite substrate of the PDC cutter may include cemented carbide material. Exemplary carbides may include, but are not limited to, silicon carbides, boron carbides, cubic boron carbides, molybdenum carbides, titanium carbides, tantalum carbides, niobium carbides, chromium carbides, vanadium carbides, iron carbides, zirconium carbides, hafnium carbides, tungsten carbides (e.g., macrocrystalline tungsten carbide, cast tungsten carbide, crushed sintered tungsten carbide, carburized tungsten carbide, etc.), and any mixture thereof. Suitable binder materials include, but are not limited to, cobalt, nickel, iron, copper, manganese, zinc, titanium, tantalum, niobium, molybdenum, chromium, any alloy thereof, and any combination thereof. The hard composite substrate 106 may also be coated with a material to increase certain properties, such as hardness or compact life. Suitable coating materials include titanium nitride, titanium carbide, titanium carbide-nitride, and titanium aluminum nitride, and the like, and any combination thereof.

The refractory layer of the interlayer bonding structure may be composed of any metal or metal alloy with a melting point above the selected bonding temperature. For example, for a bonding temperature of 1472° F., suitable refractory layer materials include tungsten, rhenium, osmium, tantalum, molybdenum, niobium, iridium, boron, ruthenium, hafnium, rhodium, vanadium, chromium, zirconium, platinum, titanium, lutetium, palladium, thulium, scandium, iron, yttrium, erbium, cobalt, holmium, nickel, dysprosium, silicon, terbium, gadolinium, beryllium, manganese, promethium, copper, samarium, gold, neodymium, silver, germanium, praseodymium, lanthanum, calcium, ytterbium, europium, arsenic, and the like, any combination thereof, and any alloy thereof. Additionally, for a bonding temperature of 1200° F., suitable refractory layer materials include the previously mentioned materials for the refractory layer in addition to cerium, strontium, barium, and aluminum, any combination thereof, any alloy thereof.

The refractory layer of the interlayer bonding structure described herein may have a thickness ranging from 10 microns to 1000 microns. When forming a bond between the hard composite substrate of the PDC cutter and the MMC of the matrix drill bit, the refractory layer may preferably have a thickness ranging from 25 microns to 150 microns.

The outer layers of the interlayer bonding structure described herein may each independently comprise of materials that directly melt or that form eutectic melts with the refractory layer. Suitable materials for outer layers that may directly melt include cerium, strontium, barium, aluminum, magnesium, antimony, tellurium, zinc, lead, cadmium, thallium, bismuth, tin, selenium, lithium, indium, iodine, sulfur, sodium, potassium, phosphorus, rubidium, gallium, cesium, and the like, any combination thereof, and any alloy thereof. Suitable materials for outer layers that may form a eutectic melt with the refractory layer include all binary systems wherein both elements have higher melting points than the bonding temperature and the lowest eutectic melting point is below the bonding temperature, any combination thereof, and any alloy thereof. These binary systems may comprise any two elements from the materials listed above for the refractory layer.

The outer layers of the interlayer bonding structure may have a thickness ranging from 0.1 micron to 10 microns.

Suitable materials for an intermediate layer may directly melt and include cerium, strontium, barium, aluminum, magnesium, antimony, tellurium, zinc, lead, cadmium, thallium, bismuth, tin, selenium, lithium, indium, iodine, sulfur, sodium, potassium, phosphorus, rubidium, gallium, cesium, and the like, any combination thereof, and any alloy thereof. Suitable materials for intermediate layer that may form a eutectic melt with the refractory layers 306,308 include all binary systems wherein both elements have higher melting points than the bonding temperature and the lowest eutectic melting point is below the bonding temperature, any combination thereof, and any alloy thereof. These binary systems may comprise any two elements from the materials listed above for the refractory layers.

The intermediate layer of the interlayer bonding structure may have a thickness ranging from 0.1 micron to 10 microns.

Embodiments described herein may include Embodiments A, B, C, or D.

Embodiment A is a method of securing a polycrystalline diamond compact (PDC) cutter to a drill bit body that comprises a metal matrix composite (MMC) where the method includes positioning a PDC cutter in a pocket of the drill bit body with an interlayer bonding structure between the PDC cutter and the drill bit body, the interlayer bonding structure comprising a first outer layer adjacent a hard composite substrate of the PDC cutter, a second outer layer adjacent the MMC of the drill bit body, and a refractory layer between the first and second outer layers; heating the interlayer bonding structure to a bonding temperature within a temperature range above a melting point of the first and second outer layers and below the melting point of the refractory layer; and maintaining the bonding temperature within the temperature range for a period of time sufficient to isothermally solidify the outer layers with the refractory layer and to react the outer layers with the hard composite substrate and to the MMC.

Optionally, Embodiment A may further include one or more of the following elements: Element 1: wherein isothermally solidifying the outer layers with the refractory layer and reacting the outer layers to the hard composite substrate and to the MMC forms: a first bond between the hard composite substrate and the refractory layer, wherein the first bond has a melting point above the melting points of the outer layers and comprises a metal-ceramic bonding portion with the hard composite substrate and a first transient liquid phase bonding portion with the refractory layer, and a second bond between the MMC of the matrix drill bit and the refractory layer, wherein the second bond comprises a metal-composite bonding portion with the MMC and a second transient liquid phase bonding portion with the refractory layer; Element 2: wherein isothermally solidifying the outer layers with the refractory layer and reacting the outer layers to the hard composite substrate and to the MMC forms a bond between the hard composite substrate and the MMC, wherein the bond transitions from a metal-ceramic bonding portion with the hard composite substrate to a transient liquid phase bond to a metal-composite bonding portion with the MMC; Element 3: wherein the refractory layer is sandwiched between and abutting the first and the second outer layers; Element 4: wherein the refractory layer is a first refractory layer adjacent to the first outer layer and a second refractory layer is adjacent to the second outer layer, wherein the interlayer bonding structure has an interior layer between the first and second refractory layers, and wherein maintaining the bonding temperature causes the intermediate layer to react or isothermally solidify with the first and second refractory layers; Element 5: the method further including maintaining the bonding temperature within the temperature range of the interlayer bonding structure for 1 minute to 6 hours; Element 6: the method further including applying pressure to the PDC cutter while heating the interlayer bonding structure; Element 7: wherein heating the interlayer bonding structure involves heating at a rate of 3° F./min to 60° F./min within 200° F. or less of the bonding temperature; Element 8: wherein heating the interlayer bonding structure is performed in an inert atmosphere; Element 9: wherein heating the interlayer bonding structure is performed below atmospheric pressure; Element 10: the method further including cooling the interlayer bonding structure at a rate of 3° F./min to 60° F./min within 200° F. or less of the bonding temperature; Element 11: the method further including assembling at least a portion of the interlayer bonding structure on the hard composite substrate; Element 12: the method further including assembling at least a portion of the interlayer bonding structure on the MMC; Element 13: the method further including applying the first outer layer to the hard composite substrate by one of: sputtering, thermal spray, physical vapor deposition, chemical vapor deposition, electrolytic deposition, or electroless deposition; and Element 14: the method further including applying the second outer layer to the MMC by one of: sputtering, thermal spray, physical vapor deposition, chemical vapor deposition, electrolytic deposition, or electroless deposition. Exemplary combinations of the foregoing elements may include, but are not limited to, Elements 1, 2, or 4 in combination with one or more of Elements 5-10; Elements 1, 2, or 4 in combination with Element 3 and optionally one or more of Elements 5-10; Element 3 in combination with one or more of Elements 5-10; Element 5 in combination with one or more of Elements 6-10; Element 6 in combination with one or more of Elements 7-10; Element 7 in combination with one or more of Elements 8-10; Element 8 in combination with one or more of Elements 9-10; Element 9 in combination with Element 10; one or more of Elements 11-14 in combination with any of the foregoing; two or more of Elements 11-14 in combination; and one or more of Elements 11-14 in combination with one or more of Elements 1-10.

Embodiment B is a method of securing a polycrystalline diamond compact (PDC) cutter to a drill bit body that comprises a metal matrix composite (MMC) where the method includes positioning a PDC cutter in a pocket of the drill bit body with an interlayer bonding structure between the PDC cutter and the drill bit body, the interlayer bonding structure comprising a first outer layer adjacent a hard composite substrate of the PDC cutter and a refractory layer adjacent the MMC of the drill bit body; heating the interlayer bonding structure to a bonding temperature within a temperature range above a melting point of the outer layer and below the melting point of the refractory layer; and maintaining the bonding temperature within the temperature range for a period of time sufficient to isothermally solidify the outer layer with the refractory layer, to react the outer layer with the hard composite substrate, and to bond the refractory layer to the MMC. Optionally, Embodiment B may further include one or more of the following elements: Elements 2-10; and Element 15: wherein isothermally the outer layer with the refractory layer, reacting the outer layer with the hard composite substrate, and bonding the refractory layer to the MMC forms: a bond between the hard composite substrate and the MMC, wherein the bond transitions from a metal-ceramic bonding portion with the hard composite substrate to a transient liquid phase bond to a metal-composite bonding portion at the MMC. Exemplary combinations of the foregoing elements may include, but are not limited to, Elements 15, 2, or 4 in combination with one or more of Elements 5-10; Elements 15, 2, or 4 in combination with Element 3 and optionally one or more of Elements 5-10; Element 3 in combination with one or more of Elements 5-10; Element 5 in combination with one or more of Elements 6-10; Element 6 in combination with one or more of Elements 7-10; Element 7 in combination with one or more of Elements 8-10; Element 8 in combination with one or more of Elements 9-10; Element 9 in combination with Element 10; one or more of Elements 11-14 in combination with any of the foregoing; two or more of Elements 11-14 in combination; and one or more of Elements 11-14 in combination with one or more of Elements 1-10.

Embodiment C is a drill bit that includes a matrix bit body comprising a MMC; and a PDC utter comprising a hard composite substrate and mounted in pockets of an exterior portion of the matrix bit body with a refractory layer between the PDC cutter and the MMC such that the PDC cutter is bonded to the MMC by a first bond between a hard composite substrate and a refractory layer and a second bond between the MMC and the refractory layer, the first bond comprising a metal-ceramic bonding portion with the hard composite substrate and a transient liquid phase bonding portion with the refractory layer. Optionally, the second bond may include a metal-composite bonding portion with the MMC and a transient liquid phase bonding portion with the refractory layer.

Embodiment D is a PDC cutter that includes a matrix bit body comprising a MMC; and a PDC cutter comprising a hard composite substrate mounted in pockets of an exterior portion of the matrix bit body by a bond between the hard composite substrate of the PDC cutter and the MMC, wherein the bond transitions from the metal-ceramic bonding portion with the hard composite substrate to a transient liquid phase bond to the metal-composite bonding portion with the MMC.

Embodiment E is a drilling assembly that includes a drill string extending into a wellbore; a pump fluidly connected to the drill string and configured to circulate a drilling fluid into the drill string and through the wellbore; and a drill bit according to Embodiments C and/or D or formed by Embodiments A and/or B attached to an end of the drill string.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A method of securing a polycrystalline diamond compact (PDC) cutter to a drill bit body that comprises a metal matrix composite (MMC), the method comprising:
positioning a PDC cutter in a pocket of the drill bit body with an interlayer bonding structure between the PDC cutter and the drill bit body, the interlayer bonding structure comprising a first outer layer adjacent a hard composite substrate of the PDC cutter, a second outer layer adjacent the MMC of the drill bit body, and a refractory layer between the first and second outer layers; heating the interlayer bonding structure to a bonding temperature within a temperature range above a melting point of the first and second outer layers and below the melting point of the refractory layer; and
maintaining the bonding temperature within the temperature range for a period of time sufficient to isothermally solidify the outer layers with the refractory layer and to react the outer layers with the hard composite substrate and to the MMC.

2. The method of claim 1, wherein isothermally solidifying the outer layers with the refractory layer and reacting the outer layers to the hard composite substrate and to the MMC forms: a first bond between the hard composite substrate and the refractory layer, wherein the first bond has a melting point above the melting points of the outer layers and comprises a metal-ceramic bonding portion with the hard composite substrate and a first transient liquid phase bonding portion with the refractory layer, and a second bond between the MMC of the matrix drill bit and the refractory layer, wherein the second bond comprises a metal-composite bonding portion with the MMC and a second transient liquid phase bonding portion with the refractory layer.

3. The method of claim 1, wherein isothermally solidifying the outer layers with the refractory layer and reacting the outer layers to the hard composite substrate and to the MMC forms a bond between the hard composite substrate and the MMC, wherein the bond transitions from a metal-ceramic bonding portion with the hard composite substrate to a transient liquid phase bond to a metal-composite bonding portion with the MMC.

4. The method of claim 1, wherein the refractory layer is adjacent to the first and the second outer layers.

5. The method of claim 1, wherein the refractory layer is a first refractory layer adjacent to the first outer layer and a second refractory layer is adjacent to the second outer layer, wherein the interlayer bonding structure has an interior layer between the first and second refractory layers, and wherein maintaining the bonding temperature causes the intermediate layer to react or isothermally solidify with the first and second refractory layers.

6. The method of claim 1 further comprising:
maintaining the bonding temperature within the temperature range for 1 minute to 6 hours.

7. The method of claim 1 further comprising:
applying pressure to the PDC cutter while heating the interlayer bonding structure.

8. The method of claim 1, wherein heating the interlayer bonding structure involves heating at a rate of 3° F./min to 60° F./min within 200° F. or less of the bonding temperature.

9. The method of claim 1, wherein heating the interlayer bonding structure is performed in an inert atmosphere.

10. The method of claim 1, wherein heating the interlayer bonding structure is performed below atmospheric pressure.

11. The method of claim 1 further comprising:
cooling the interlayer bonding structure at a rate of 3° F./min to 60° F./min within 200° F. or less of the bonding temperature.

12. A method of securing a polycrystalline diamond compact (PDC) cutter to a drill bit body that comprises a metal matrix composite (MMC), the method comprising:
positioning a PDC cutter in a pocket of the drill bit body with an interlayer bonding structure between the PDC cutter and the drill bit body, the interlayer bonding structure comprising a first outer layer adjacent a hard composite substrate of the PDC cutter and a refractory layer adjacent the MMC of the drill bit body;
heating the interlayer bonding structure to a bonding temperature within a temperature range above a melting point of the outer layer and below the melting point of the refractory layer; and
maintaining the bonding temperature within the temperature range for a period of time sufficient to isothermally solidify the outer layer with the refractory layer, to react the outer layer with the hard composite substrate, and to bond the refractory layer to the MMC.

13. The method of claim 12, wherein isothermally the outer layer with the refractory layer, reacting the outer layer with the hard composite substrate, and bonding the refractory layer to the MMC forms: a bond between the hard composite substrate and the refractory layer, wherein the first bond has a melting point above the melting points of the outer layer and comprises a metal-ceramic bonding portion with the hard composite substrate and a transient liquid phase bonding portion with the refractory layer.

14. The method of claim 12, wherein isothermally the outer layer with the refractory layer, reacting the outer layer with the hard composite substrate, and bonding the refractory layer to the MMC forms: a bond between the hard composite substrate and the MMC, wherein the bond transitions from a metal-ceramic bonding portion with the hard composite substrate to a transient liquid phase bond to a metal-composite bonding portion at the MMC.

15. The method of claim 12, wherein heating the interlayer bonding structure involves heating at a rate of 3° F./min to 60° F./min within 200° F. or less of the bonding temperature.

16. A drill bit comprising:
a matrix bit body comprising a metal matrix composite (MMC); and
a polycrystalline diamond compact (PDC) cutter comprising a hard composite substrate and mounted in pockets of an exterior portion of the matrix bit body with a refractory layer between the PDC cutter and the MMC such that the PDC cutter is bonded to the MMC by a first bond between a hard composite substrate and a refractory layer and a second bond between the MMC and the refractory layer, the first bond comprising a metal-ceramic bonding portion with the hard composite substrate and a transient liquid phase bonding portion with the refractory layer.

17. The drill bit of claim 16, wherein the second bond comprises a metal-composite bonding portion with the MMC and a transient liquid phase bonding portion with the refractory layer.

18. A drilling assembly comprising:
a drill string extending into a wellbore;
a pump fluidly connected to the drill string and configured to circulate a drilling fluid into the drill string and through the wellbore; and
a drill bit according to claim 16 attached to an end of the drill string.

19. (canceled)

20. (canceled)
